(19) United States
(12) Patent Application Publication
(10) Pub. No.: US 2002/0027164 A1
(43) Pub. Date: Mar. 7, 2002

(54) Portable computing apparatus particularly useful in a weight management program

(76) Inventors: James R. Mault, Evergreen, CO (US); John Sanderson, Bainbridge Island, WA (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 09/949,073

(22) Filed: Sep. 7, 2001

Related U.S. Application Data
(60) Provisional application No. 60/230,860, filed on Sep. 7, 2000.
(60) Provisional application No. 60/234,154, filed on Sep. 21, 2000.

(51) Int. Cl. G06K 7/10

(52) U.S. Cl. 235/462.46

(57) ABSTRACT

Portable computing apparatus for aiding a user in the monitoring of the consumption of consumable items, such as food items or prescribed medicaments, and reordering such items includes a common database for use in monitoring the items as consumed, and for preparing the reorder list at the proper time. The apparatus preferably includes an imaging device for recording the image of the item to be consumed, and recognition circuitry for utilizing the recorded image to identify the item and also to provide information concerning its nutritional content in a weight management program. The consumable item may also be identified in other manners, such as by a barcode reader, or a voice-recognition circuit.

### RELATED APPLICATIONS

The present application is related to provisional application 60/230,860, filed Sep. 7, 2000, and to provisional application 60/234,154, filed Sep. 21, 2000, the contents of which applications are hereby incorporated by reference, and claims the priority dates of said applications.

### FIELD AND BACKGROUND OF THE INVENTION

The present invention relates to a portable computing apparatus or device for use in a weight management program, and is therefore described below particularly with respect to this application. It will be appreciated, however, that the invention could be used in other applications, such as in a drug administering program, to better assure that prescribed medicaments are properly taken by the user at the prescribed times.

A person expends calories through metabolic processes. The total energy expended by the person (TEE) is the sum of resting energy expenditure (REE) and activity related energy expenditure (AEE); that is:

TEE=REE+AEE

The calorie balance for a person is determined by comparing TEE with the caloric intake of the person. If REE is known, the calorie balance may be found if caloric intake and AEE are monitored.

A person's REE can be estimated using a formula based on his or her height and weight. The formula can be improved by including the effects of age and gender, but the result obtained is still only an estimate based on population averages. Preferably, REE is measured using an indirect calorimeter, e.g. the gas exchange monitor (GEM) invented by James R. Mault, described in U.S. patent application Ser. No. 09/630,398, incorporated herein by reference. An accurate value of REE can be determined for an individual using the GEM, e.g. as part of an improved calorie balance monitoring system.

AEE can be determined or estimated using a variety of methods. The person may record activities performed over a day, which can be converted to values of AEE using printed tables or a database. Values of AEE for an average person performing the activities or values for a demographic subset may be used. There is some loss of accuracy if typical values for an average person are used. However, estimating AEE may still provide acceptable accuracy in TEE if an accurate value of REE is used, as REE generally makes a significantly larger contribution to TEE than does AEE.

An indirect calorimeter can also be used to determine the metabolic rate of the person during various activities, e.g., while exercising (e.g. walking, jogging, running, swimming, cycling, playing various sports, etc.), or while engaged in other activities (e.g. computer operation, watching TV, housework, gardening, driving, etc.). These values may then used in determining AEE for a given day's activities.

Signals corresponding to physical activity may be obtained from a physical activity sensor, such as a pedometer, body mounted accelerometers, etc. These signals can be calibrated against accurate metabolic rate values determined using an indirect calorimeter, or against typical energy expenditures for the activities, and used to determine AEE. Signals related to activity levels may also be obtained from physiological sensors, e.g. respiration, temperature, and heart rate sensors. Physiological sensors may also be used to detect eating, and hence improve diet logging accuracy.

It is well known to provide computer devices for monitoring dietary consumption, which devices store and utilize data relating to the nutritional content of numerous foods. Such devices are described, for example, in U.S. Pat. Nos. 5,412,564; 5,841,115; and 4,891,756. It is also well known to utilize a computer for assisting a shopper, as described, for example, in U.S. Pat. No. 5,047,614.

While using such devices eliminates the need to look up calorie values in tables, their use is still very time consuming. It may be possible to find time near the end of the day to enter items into an electronic diet log, but then it may be difficult to remember the foods consumed. A busy person may easily omit items.

### OBJECTS AND BRIEF SUMMARY OF THE INVENTION

One object of this invention is to provide an improved diet logging apparatus such that a busy person may accurately record food, drinks, medications, or other items they may consume over time.

Another object of the invention is to provide an apparatus which may be used both for monitoring the consumption of consumable items, such as food items or prescription items, but which can also be used for reordering the consumable items as and when needed.

Another object of the present invention is to provide a method of diet management having a number of advantages particularly when used in a weight control program.

According to one aspect of the present invention, there is provided portable computing apparatus for aiding a user in monitoring the consumption of consumable items and in reordering the items, comprising: a housing constructed and dimensioned to be handheld by the user; a storage device carried by the housing for storing data concerning the items; item-identification input means carried by the housing for inputting item-identification information identifying the items as and when to be consumed by the user; a display carried by the housing; and a processor within the housing programmed to process the inputted item-identification information with respect to the data stored in the storage device: (a) to maintain a log of the items as they are consumed; (b) to prepare a list of items to be reordered; and (c) to selectively display the log of consumed items and the list of items to be reordered.

In the preferred embodiments of the invention described below, the items to be consumed are food items, and the storage device includes a first database for pre-storing identification data to identify the food items as they are consumed and/or as they are to be included in the reorder list, and a second database for pre-storing nutritional information of the food items as they are consumed and/or included in the reorder list.

According to further features in the described preferred embodiment, the storage device further includes a third database for pre-storing personal health information relating to the personal health of the user in order to guide the user in consuming food items and/or in preparing said reorder list.

In another embodiment, the items to be consumed are prescribed medicaments to be taken by the user at prescribed times, the processor controlling the display to advise the user of the prescribed times, and to aid the user in timely reordering the prescribed medicaments.

As will be described more particularly below, by thus combining the consumption-monitoring function with the reordering function in a single computing device, the invention provides a smarter, more user-friendly apparatus, as well as a number of additional benefits.

According to further features in the described preferred embodiments, the item-identification input means may be or include a barcode reader, an image-sensing device, or a voice-sensing device. Particularly beneficial results are obtainable when the input means is or includes an image-sensing device. This will enable the user merely to photograph a meal before it is eaten to record the food items then being consumed, thereby better assuring that the calorie consumption of the person is accurately recorded in a simple and convenient manner.

According to another aspect of the present invention, therefore, there is provided portable computing apparatus for aiding a user in monitoring the consumption of food items, comprising: a housing constructed and dimensioned to be handheld; a storage device carried by the housing for storing data concerning the food items; an image sensing device for sensing the image of an item to be consumed or the food package thereof; a display carried by the housing; and a processor within the housing programmed to process the sensed image to identify the food item thereof to maintain a log of the items as they are consumed.

According to further features in various embodiments of the invention described below, the apparatus may be provided with a recognition circuit for identifying the items being consumed, a removable storage device for storing this information and transferring it to another processor for processing, and/or an output port to be connected via a communication channel to a remotely-located processor to enable that information to be inputted to the remotely-located processor.

According to another aspect of the present invention, there is provided a method of diet management by a user comprising the steps: recording optical images of food to be consumed by the user; analyzing the optical images to identify the constituents of said food and the quantity of each constituent; and computing the nutritional content of each of the constituents in said food.

In one preferred embodiment described below, the analyzing step is performed at the same site as the recording step.

Other embodiments are described wherein the recording step is performed at a first site, and the analyzing step is performed at a second site different from the first site.

In one described preferred embodiment, the optical image is recorded on a removable storage device at the first site, and the storage device is removed and transferred to a computer apparatus at the second site for analysis. In another described preferred embodiment, the optical image is recorded on a portable, handheld device at the first site, and is transmitted via a communications channel to the computer apparatus at the second site. In the latter described preferred embodiment, the computer apparatus also performs the analysis at the second site, and transmits the results of the analysis via the communication channel to the portable, handheld device at the first site.

According to further features described below, the diet management is a part of a weight control program in which the total energy expenditure by the user is measured, and the computed nutritional content of the food consumed by the user is determined and subtracted from the measured total energy expenditure to produce a calorie balance useful for weight control. According to further features, the total energy expenditure measured includes a measurement of the resting energy expenditure by the user, and a measurement of the activity-related energy expenditure by the user. Preferably, the resting energy expenditure is measured by an indirect calorimeter carried by the user, and the activity-related energy expenditure is measured by an activity sensor carried by the user.

Further features and advantages of the invention will be apparent from the description below.

### BRIEF DESCRIPTION OF THE DRAWINGS

The invention is herein described, by way of example only, with reference to the accompanying drawings, wherein:

FIG. 1 illustrates one form of portable computing apparatus constructed in accordance with the present invention;

FIG. 2 illustrates another form of such apparatus constructed in accordance with the present invention;

FIG. 3 is a block diagram of a system utilizing the apparatus of FIG. 1 or FIG. 2 to be used for monitoring the consumption of items, such as food items or prescriptions, and to prepare a reorder list for the consumed items;

FIG. 4 is a block diagram illustrating another system constructed in accordance with the present invention;

FIG. 5 illustrates one manner of using the computing apparatus of FIG. 4 for imaging and displaying an image of the food item to be consumed;

FIG. 6 illustrates another form of such apparatus for imaging and displaying the identification of the food item to be consumed;

FIG. 7A illustrates one form of apparatus that may be used for recording the image of an item to be consumed on a removable memory card; whereas FIG. 7B illustrates the application of such a memory card to a handheld device for processing by the user;

FIG. 8 illustrates one manner in which such a handheld device may display the nutritional content of the food item to be consumed;

FIG. 9A diagrammatically illustrates one form of wrist-applied apparatus constructed in accordance with the present invention; and

FIG. 9B is a pictorial illustration of the apparatus of FIG. 9A.

### DESCRIPTION OF PREFERRED EMBODIMENTS

The portable computing apparatus of the present invention may be embodied in any one of a number of different types of personal digital assistant devices (PDAs). For purposes of this application, PDAs are defined to include all types of portable computing devices, including palm size and handheld computers, portable and cellular phones, pagers, and any other devices which are portable and possess some computing power.

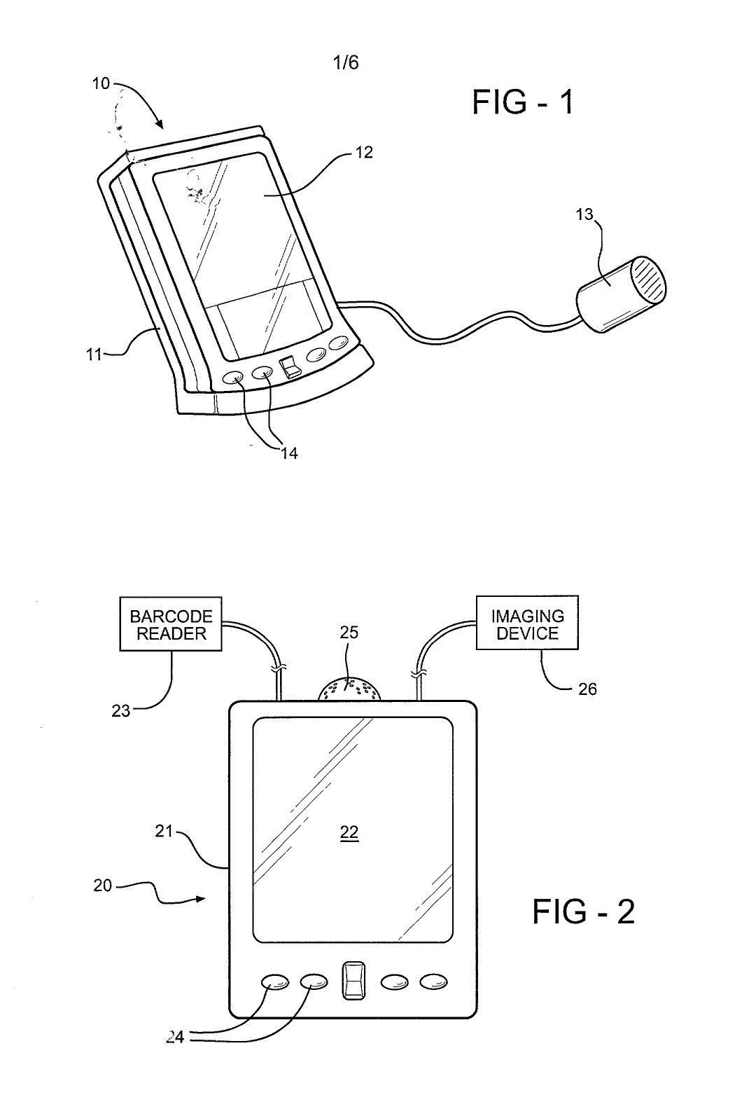

FIG. 1 illustrates one form of PDA constructed in accordance with the present invention, and therein generally designated 10. Such a device includes a housing 11 constructed and dimensioned so as to be handheld; a display 12 carried by the housing 11; an item-identification input means in the form of a barcode reader 13 for inputting information identifying various items as and when such items are to be consumed by the user; and a plurality of buttons 14 enabling the user to input other types of data, as well as to perform various control operations. In the embodiment of FIG. 1, the data may be entered by the barcode reader 13 or by the appropriate buttons 14. The PDA may be one in which the user may also input data by using an electronic pen, as well known in the art.

FIG. 1 illustrates the barcode reader 13 as being cable-connected to the PDA 10. It will be appreciated that the barcode reader may be incorporated in the PDA 10 itself, may constitute a plug-in module for a PDA of the type disclosed in U.S. Pat. No. 5,899,855, may communicate with the PDA via wireless means, or may be attached to a processor independent of the PDA 10.

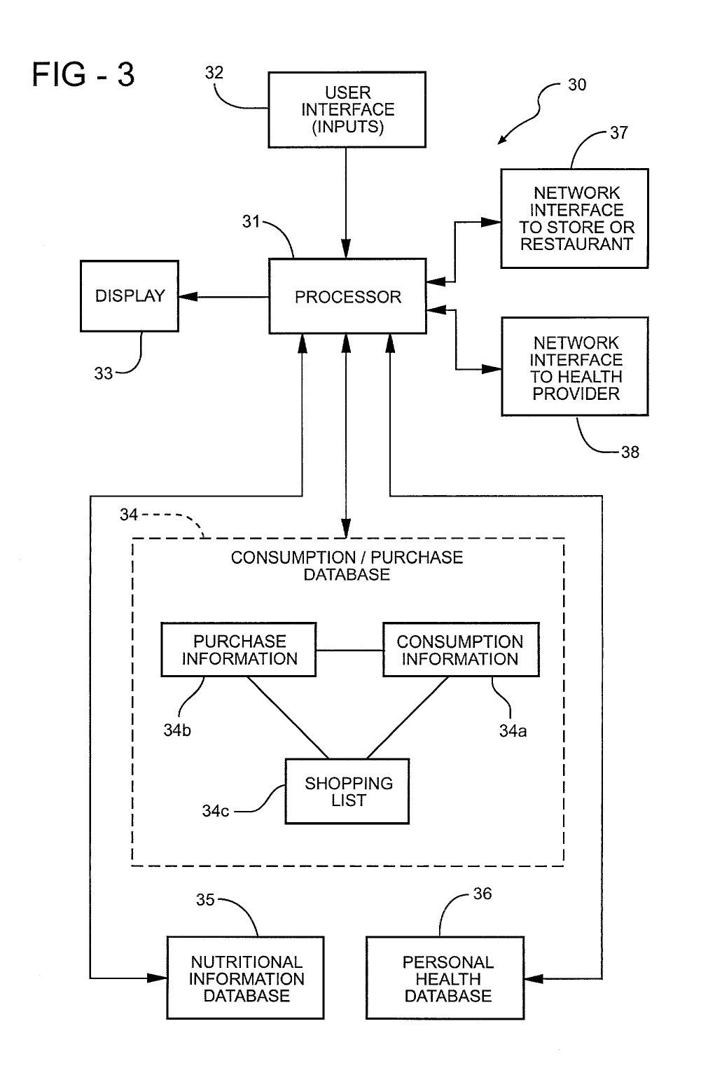

The PDA 10 in FIG. 1 further includes a processor within the housing 11, which processor performs a number of functions, as will be described more particularly below with respect to FIG. 3.

FIG. 2 illustrates another embodiment of the invention, also including a PDA, therein generally designated 20, having a housing 21, a display 22, a barcode reader 23, and a plurality of input/control buttons 24, corresponding to the elements described above in FIG. 1. In FIG. 2, however, the PDA 20 further includes a microphone 25 and an imaging device 26, enabling the user to enter an identification of the items to be consumed by enunciating the item and/or by photographing the item, as it is to be consumed. Both units may be plug-in modules, built-in, or connected by cable or wirelessly.

One example of electronic system that may be included in the PDA 10 of FIG. 1 or PDA 20 of FIG. 2 is illustrated in the block diagram of FIG. 3. Such an electronic system, therein generally designated 30, includes a processor 31 communicating with the user interface 32, constituted of the various input means described above with respect to FIGS. 1 and 2, and the display 33.

The system illustrated in FIG. 3 further includes a storage device for storing a first database 34, a second database 35, and a third database 36. Database 34 pre-stores identification data to identify the food items as inputted via the user interface 32 to compile the consumption information 34a and the purchase information 34b, the latter to be used in preparing a shopping list 34c for reordering the consumed items. Database 35 pre-stores nutritional information of the food items as they are consumed and/or included in the reorder list. Database 36 pre-stores personal health information relating to the personal health of the user in order to guide the user in consuming the food items and/or in preparing the reorder list.

The system illustrated in FIG. 3 further includes a network interface 37 to a store or restaurant for use in inputting the information of the items to be consumed, and also a network interface 38 to a health professional service for processing the information and to provide guidance to the user with respect to such processed information.

The illustrated system operates to assist individuals in attaining their dietary goals and also in preparing shopping lists for reordering the consumed items. Information relevant to the individual's health is inputted into the illustrated computing apparatus, stored, and analyzed, and the computing apparatus returns suggestions and feedback to the user.

For example, upon purchasing a food product, the user inputs information regarding the product. This information may be entered by scanning the barcode provided on the packaging of the product means of the barcode reader 13, FIG. 1, or 23, FIG. 2, to retrieve all nutritional information for that product. Alternatively, the user may enter the identity and quantity of a food, upon purchasing the food, enunciating the identity and quantity of the food into microphone 25 (FIG. 2), or by photographing the respective food by imaging device 26 (FIG. 2). The computing apparatus 30 thus records the purchase of the food for later reference. The nutritional information of foods not included in the nutritional database can be entered by the user and stored in database 35.

Additionally, by scanning the barcodes of the packaging of food products, or by recording the images of such packaging, the user can assemble a shopping list before traveling to the store. Items without packaging may be entered manually or by voice via the microphone 25 (FIG. 2). This list, along with other pertinent data, can then be printed at the user's home or the store at which the user later shops. The computing apparatus may also be used to remind the user what items and products the user has run out of.

The user may also identify in a similar manner a food that is to be consumed. By utilizing a single database in performing functions relating to both the purchase and consumption of foods, as illustrated in FIG. 3, less memory is required in the computing device. Further, because of this synergism, the computing device may perform other important tasks in a diet management program, or in a prescription administration program, not capable of being performed by prior art devices. Thus, the user may also enter personal data regarding himself or herself or another individual. This personal data may include age, gender, health problems, height, weight, and other factors pertinent to the maintenance of a diet. The individual data is stored by the computing device in the personal health database 36 shown in FIG. 3, and may be used by the computing device for the purpose of analysis, as discussed below.

The above-mentioned inputs are preferably all stored in the storage section (e.g., a RAM) of the computing device in FIG. 3. Upon every entry of a food intended to be purchased or consumed, the computing device analyzes the user's choice of food and then provides feedback to the user based on the food choice and other stored data. This feedback may include the nutritional information of the food choice as well as information regarding the overall progress of the individual's diet.

This feedback provided by the PDA computing device 10 or 20 may also include a suggestion as to an alternate product with superior nutrition. In order to provide a list of alternate products, the computing device may use the network interface 37 (FIG. 3) to be in communication with the store or restaurant which the user frequents. If the user is at home and intends to consume food previously purchased, the computing device can retrieve previously entered data in order to provide feedback.

Any information stored in the PDA computing device 10 or 20 may be printed by conventional means. A printing device may be provided at locations such as grocery stores, restaurants, and the user's home. Additionally, the computing device can be placed in electrical communication with a personal computer to facilitate the printing of data at the user's home. Connection to a personal computer may also make data entry into the computing device easier.

Further, in another embodiment of the present invention, a smart card, or other portable data storage device, may be provided to allow the user to transfer data to and from the PDA 10 or 20. The PDA computing device may also create graphs, tables, and charts based on the data it has stored. These visual aids may then be printed in the manner described above, or displayed by the PDA. The PDA computing device 10, 20 may also be capable of communicating with other computers by such means as the Internet or a modem. In this manner, an individual's physician may monitor the progress and health of the individual without the need for an office visit.

In using the described apparatus for shopping, the shopping may be carried out either on-line or at the store. A shopping list may be created by choosing items from a menu displayed on the PDA. Personal preferences, product groupings, dietary requirements, and marketing considerations may be used in determining the order of items displayed on the PDA. Product vendors may pay a fee or subscription to obtain a more prominent menu listing, analogous to stocking fees presently paid to grocery stores. The person's preferences may be derived from various sources such as previous purchase data, response to adverts which may, for example, be displayed on the PDA as part of a subscription service, reception of electronic coupons via a communications network, barcode scanning of printed coupons, scanning of previously purchased packages, and responses to questions.

The person selects items using the PDA 10 or 20, e.g. using keys, stylus, tracker ball, roller, finger motion detector, track pad, or other method. The nutritional content of each selection can be obtained from database 35. For example, the nutritional information for previously purchased products may be stored in database 35, and if an unfamiliar product is encountered, the database may be enhanced by receiving data from a remote database over communications network 37. For example, nutritional data may be supplied by a food vendor from their own database, possibly produced using food manufacturer information. Nutritional data may be compared against dietary goals established using the PDA. Dietary preferences may be entered into the PDA, and used to flag chosen foods. For example, a person with peanut allergies may enter that information into the personal health database 36, so that if a peanut-containing food is selected, a warning message or signal would be produced by the PDA.

Other methods of creating a shopping list include creating voice records via microphone 25, combined with voice recognition software within the processor 31; scanning the barcode on a package (such as an empty package which needs to be replaced) via barcode scanner 13 or 23; scanning printed materials such as coupons or other advertising materials either using the barcode scanner 13 or 23, imaging device 26, or by simple optical character recognition. A shopping list may be generated automatically based on some or all of the following: usual purchase habits: dietary needs, previous purchase information, diet log information and purchase information (the combination of which enables an estimation of when a food will run out), expiration date information on previously purchased foods, memos made on the PDA 10 or 20, special offers, and communications from any suitably adapted food storage containers the person may possess. Data from several persons may be combined, for example for a family. A person may instruct the PDA to take advantage of any discounts available, or to retain product loyalty to certain brands. The PDA may suggest complete, nutritionally balanced meals to the person, then use the chosen meals to generate a shopping list based on the meals chosen. The diet log and previous purchase information allows the existence of currently owned items to be determined and removed from the shopping list. The PDA may question the person on whether previously purchased items (such as perishables) are still available and usable.

After completion (and after any further modification) of a list of items to purchase (shopping list), the person may obtain the total cost and a breakdown of nutritional content of the food items purchased. This may include the content of calories, fat, protein, minerals, and vitamins, along with any other parameter of interest such as salt, sugar, or saturated fat content. If the purchase seems nutritionally unbalanced, particularly in regard to any dietary goals, additions, replacements, and deletions may be suggested. For example, if the salt content of the food order is overall high when compared to the restrictions in the personal health database 36, deletion of a salt-heavy snack from the purchase list might be suggested. The purchase information is used by diet logging software to facilitate diet logging. For example, if a person enters chocolate ice cream into the diet log, and purchase records contains a reference to a particular brand of chocolate ice cream being purchased, this brand would be presented first on any menu or other list based diet log option. The default might be to assume that it was the food just purchased.

As indicated earlier, a person may use the described apparatus for ordering items over a communications network e.g. using the Internet. The shopping list would be created using the PDA 10 or 20, and would be transmitted to the on-line store over communications network 37 (either as items are chosen, or at the completion of the list). The on-line store may suggest alternatives to the chosen items, due to nutritional, cost, promotional, or other marketing considerations. A fee may be paid by a food supplier to the on-line grocery store to suggest the supplier's products. Own brand alternatives may be suggested by the on-line grocery store. The on-line grocery may also provide electronic coupons, as described in more detail later. The PDA may then authorize the debit of an account to pay for the purchase. A shopping list may be submitted to a number of on-line vendors, and the cost of the purchase may be optimized by the selection of one or more of the vendors to fill the order according to cost or other considerations.

As also indicated above, the person may use the device to prepare a shopping list in advance of entering the grocery store. The device may assist in the selection of nutritionally balanced foods, based on accepted health wisdom or on the personal condition of the individual as set forth in the personal health database. The device may be used to prepare a printed shopping list for the person, to show a list using a display, to display a map of the store showing the location of the items ordered, to display a list of items in an order related to the order that they will be encountered in the store, to check off items as they are purchased, and to suggest product alternatives on demand.

The PDA 10 or 20 can be used to scan items purchased in a store. The nutritional information related to purchases is recorded within database 35 of the PDA, and may be supplied by either the store, the food manufacturer, or a separate diet logging business which may have supplied the PDA. The person may use the barcode scanner 13, 23 in order to find nutritional information before the purchase decision is made. Alternatives to selected items may be suggested, based on known preferences of the person, cost savings, better nutritional content, possession of coupons (which may be electronic or previously scanned), marketing considerations, known preferences of other people which might consume the food, discounts available to people buying other combinations of items, or other reasons.

Alternatively, information may be transferred to the person's PDA 10 or 20 from equipment in the store, such as an adapted cash register with access to the communications network 37, so as to obtain nutrition information on items purchased. The PDA may transmit the purchase-related data to another location, such as a database accessible by the person, using communications network 38 (such as through an Internet website).

The PDA 10, 20 may display the nutritional information of a food item as it is selected and scanned. High fat items may lead to an alert sounding. A voice synthesizer may be provided in the PDA to adopt a scolding tone if inappropriate foods are selected. The PDA can assist location of required items within a store, for example by displaying the aisle number. A local communications network within the store may be used to supply any required information, e.g. using a local wireless network.

The grocery store may provide its own scanner for shopping, which may be handheld, mounted on a cart, or otherwise disposed at the convenience of the shopper. A shopping list may be transmitted to the store's scanner by any convenient method, such as a cable link, interface, IR link, communications network, other wireless link, or memory card transfer. Purchase data and nutrition information collected by the store's scanner can be transferred to the PDA before leaving the store.

Scanning of food products with the PDA 10, 20 may be used to replace the conventional checkout procedure. At the end of the shopping trip, the PDA may present a list of items purchased and the total cost to the person. The person may then authorize a debit from an account to pay for the goods, and then leave the store subject to any necessary security checks. The PDA may automatically authorize a debit to pay for the items.

The person may use the PDA 10, 20 to make informal records of food eaten (such as notes, time-stamps, image records, voice records), and to store information (such as product identity and nutrition details) provided by food vendors (such as restaurants, on-line retailers, supplier of diet products, vending machines, and grocery stores). Barcodes on product packages may be scanned and nutritional information retrieved from database 35. During creation of a complete diet log, purchase information obtained from food vendors may be accessed to improve the accuracy of the diet log. For example, if a yogurt was consumed, the PDA could access the nutrition information related to recently purchased yogurts. Also, purchase information may be used to streamline menus of possible food items presented to the user of the device. If food was purchased from a vending machine, the vending machine may transfer nutrition data to the PDA to assist in diet logging.

Diet logging devices available today typically present long lists of various possible food types and brand name options. These conventional devices try to include any item a person may possibly buy, and then to present all options to them at all times. The apparatus described herein allows the presented menus to be restricted to only the items that are likely to have been consumed. For example, if a person chooses “frozen pizza” (or some other food type) from a menu, the list of frozen pizza brand names presented to the person can be restricted to only the types previously purchased by the person. Extended menus may still be presented on request.

As indicated earlier, the PDA 10, 20 may also be used to scan coupons in a printed publication. Product information, discount, and an authorization code can be recorded on the PDA. Nutrition information may then be retrieved from database 35 using the product identification code. This information may be used in a later transaction made by using the PDA, or by using another device used to execute the transaction which can communicate with the PDA. Coupons may also be received electronically through a communications network such as the Internet. The information in these electronic communications could contain a product identity code, a price or discount, an authorization code, and nutritional information.

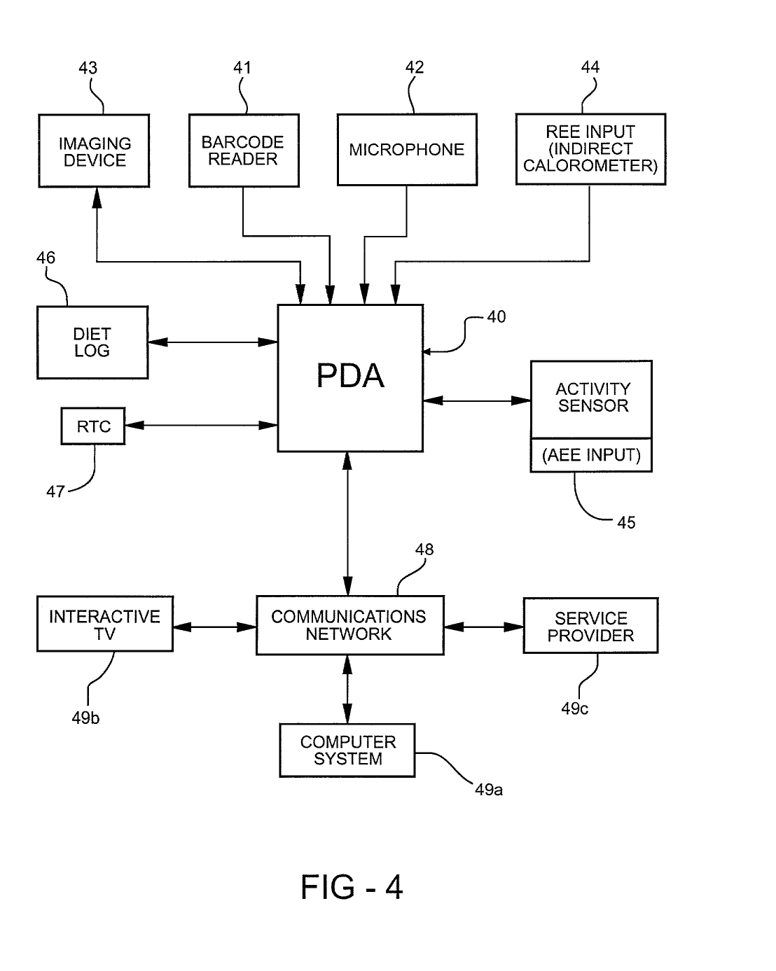

FIG. 4 illustrates computer apparatus, similar to that described above, but more particularly showing the means for measuring and inputting the energy expended by the user in order to enable the processor to compute a calorie balance of the calories in the food items consumed, as inputted in the manner described above, less the calories in the energy expended by the user.

The apparatus illustrated in FIG. 4 includes a PDA, therein generally designated 40, having the various inputs as described above, for example in FIG. 2, including a barcode reader 41, a microphone 42, and an imaging device 43, for entering calorie and other nutritional information concerning the food items as they are to be consumed. The system illustrated in FIG. 4 further includes an indirect calorimeter 44, or other device, for inputting the resting energy expenditure (REE) of the user, and an activity sensor 45 for inputting the activity energy expenditure (AEE) of the user. As indicated earlier, the total energy expenditure (TEE) which is to be used for computing the calorie balance is the sum of the REE inputted by device 44, and the AEE inputted by the activity sensor 45.

Activity sensor 45 is preferably a body-mounted device which outputs an electrical signal related to the physical activity of the user. Such output signals may be transmitted to the PDA 40 using, e.g. the Bluetooth radio transmission protocol, a nonvolatile memory medium such as a memory card, IR links, optical links, cables, wires, electrical interfaces, etc. Activity sensor 45 may physically resemble a memory card which in use is held on the body or belt of a person, and then plugged into the PDA at convenient times. The PDA 40 and activity sensor 45 may also be combined, e.g. the PDA acting as an activity sensor when carried on a belt.

Besides determining (by estimation or measurement) the total value of the expended energy (TEE), it is necessary to determine the calories consumed in order to obtain an accurate determination of calorie balance for the person. The information recorded may just be in the form of caloric value, but preferably additional nutritional information is recorded such as fat content, protein content, fiber content, mineral content, vitamin content, etc. so as to assist the person in achieving a healthy diet.

Food, beverage, medicine, and nutraceutical items are recorded as consumed, using the barcode reader 41, the microphone 42, and/or the imaging device 43, to produce a diet log 46, which preferably exists in the memory of the PDA 40. The foregoing input devices are preferably associated with the PDA 40, but a separate device may be used. The PDA also includes a real time clock (RTC) 47, so the time that the food items are consumed may be recorded. A recent diet log (e.g. for the previous month) is also preferably stored in the PDA 40, with archival and backup versions stored elsewhere.

The PDA 40 preferably has access to a communications network 48. Such network is preferably the Internet but could also be a local network, CATV system, telephone network, private wireless network, etc. The consumed food items, diet log information, physical activity data, and the person's weight and other useful physiological data may be transmitted from the PDA 40 to computer system 49a, e.g. a remote server. The person, or other authorized people (e.g. physician, health-related business employee, dietician, personal trainer, etc.) may access the data e.g. via a website. Feedback may be provided to the person via the PDA 40 or via another electronic device such as an interactive TV 49b. Other devices may be used to provide feedback, e.g. Internet access device, Web TV, television, personal computer, pager, phone, and other electronic devices. Feedback provided to the person can controlled by the data collected by the system. The communications network 48 can be used to provide the person, via a content provider device 49c, with information useful to diet logging, e.g. nutritional information of items purchased, information about prescribed drugs, etc.

Lifestyle data, e.g. relating to activities, food consumed, medications, drinks, environmental conditions, etc., may be collected and stored in a database in computer system 49a. The data collected may then be used to provide customized feedback to the person. For example, a TV channel may broadcast health-related content and segments may be chosen, based on a person's lifestyle, and provided to the person via the interactive TV channel 49b.

Particular advantages are provided when the PDA 40 is equipped with the imaging device 43 to record images of items consumed. The PDA may have a built-in imaging sensor array, or may interface with an accessory device having an imaging sensor array (e.g. a plug-in accessory). A digital camera may be used to record images. Imaging and image processing methods may be used to record, identify, and obtain information regarding items consumed.

For example, if the person intends to eat a plate of food containing various food articles, he or she would capture an image of the plate of food using the PDA 40 and record this image in its memory. At a later time, the person can review the stored images, identify the food items consumed, and enter the food items into the diet log 46. The advantage of this method is that recording images at the time of eating is easy and convenient, and the more time-consuming process of creating a diet log of foods eaten can be postponed until time is available. Such a service can also be provided by a service provider 49c at a remote location and communicated to the user's PDA 40 via the communication network 48.

The food portion size is also used in the determination of the calorie content. Portion size may be determined using image analysis. Portion size can be determined from a combination of the image size and the distance to the object. The distance may be found using focusing methods, for example the IR methods commonly found on portable cameras, or range finding techniques, ultrasound methods, etc. Alternatively, a standard sized object may be included in the image, e.g. a finger of the person, a coin, a fork, a sticker, etc. Imaging can also be used to record the initial portion size of a meal, and the size of the leftovers, so that fractional servings can be estimated.

The microphone 42 may be used to enter individual items, for example a banana to be eaten by the user. In such case, the user needs only to enunciate the word “banana,” and also indicate the size (large, medium, small) and/or the portion (whole, half), whereupon voice recognition circuitry within the PDA 40 would identify the food item and the portion thereof

The barcode reader 41 could be used to read the barcode on packages of the food item to be consumed.

It will be appreciated that the apparatus need not include all the foregoing input devices, but include, for example, only the imaging device 43, since particular advantages are provided when such a device is included as briefly discussed above.

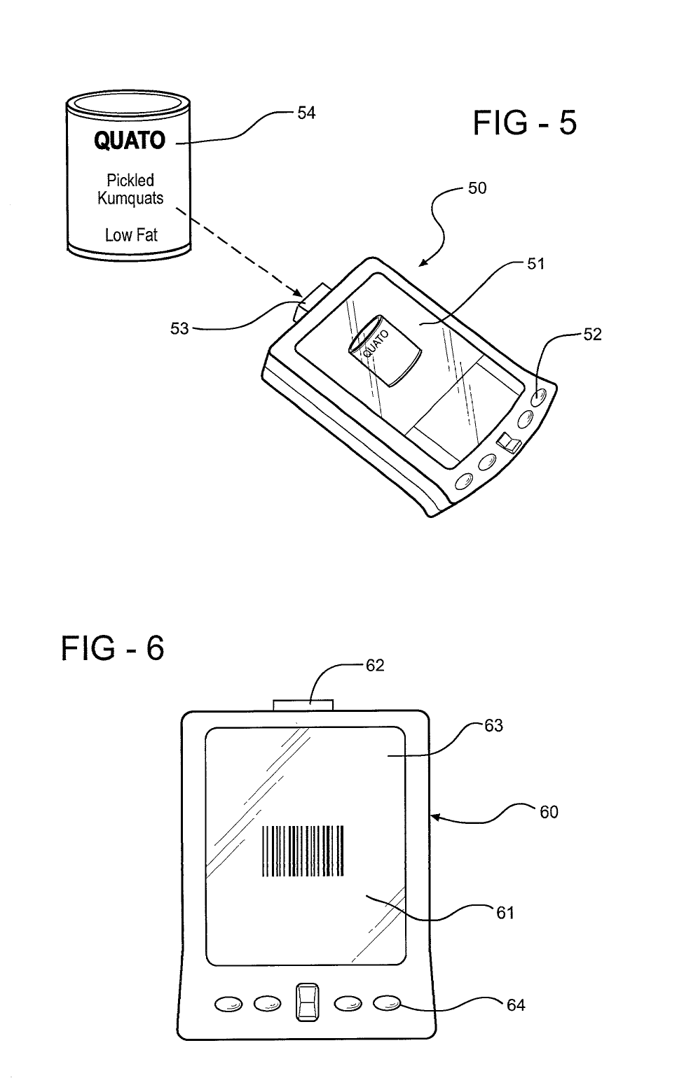

FIG. 5 shows a PDA 50 with display 51, buttons 52, and imaging device 53 directed at a can of pickles 54. The display 51 indicates the image to be captured, and a button such as 52 may be pressed to record the image.

Image processing techniques can be used to identify food items from images. For packaged foods, optical character recognition may be used to record and identify nutritional information and/or identify the item consumed. Computer analysis of images may be carried out on the PDA or another computer system may be used in communication with the PDA. For example, an image of food packaging may be used to identify the food contained. An image of the nutritional content information panel provided by the manufacturer on the package may also be recorded. Optical character recognition may be used to obtain information from the image for storage in a diet log. An image of a box of corn flakes may be recognized by a computer as such, and used to generate a corn flake serving record in a diet log. Computer analysis may be used as a first attempt in producing a diet log, and if unsuccessful, the image can be passed to a human for analysis.

For non-packaged foods, e.g. restaurant meals, image analysis may also be used in identifying the food items. Imaging at a number of wavelengths, followed by false color image generation, can be used to help identify image components. Spectroscopic imaging can be used in computer-assisted food recognition.

Image processing, image recognition, and pattern recognition algorithms are useful in recording the diet log. Algorithms may be applied to color images, or images recorded at a number of different wavelengths (e.g. in the IR, optical, and UV) which may assist identification.

An important aspect of the described apparatus is that an electronic diet log 46 (FIG. 4) may be created by any person with access to the recorded images. After recording an image using the PDA 40, the image may be transferred to another location using communications network 48. For example, the image may be transmitted via a wireless Internet connection to a service provider computer system 49c. The person may subscribe to a health or diet monitoring program, e.g. through a subscription. An employee (i.e. regular employee, contractor, associate, employee of related business, etc.) of the diet monitoring business may then create a diet log for the person based on the recorded images. Medications may also be recorded and identified. The person may access the created diet log, e.g. through an Internet connection, and edit the record if necessary.

An advantage of having the diet business employee create the diet log is that less biased estimates of portion sizes will be recorded as there is no incentive to underestimate them. Another advantage is that the diet log can be created quickly and with little effort on the part of the person. For example, the person enters a restaurant, chooses a food plate item from the menu, and images the menu choice. An image of the delivered food is also captured. Images are transmitted via a wireless Internet connection to a remote server of a service provider 49c. An employee of the diet business with access to the remote server then generates a diet log entry for the person in the restaurant. A message could then be sent back to the person eating in the restaurant. For example, he or she may be advised not to complete the meal in order to remain on a diet program.

Bar codes can also be used in food item identification. Thus, the PDA 40 may incorporate a barcode reader 41 as described above; or alternatively, barcodes may be identified from a recorded image of the barcode using image analysis. The barcode (e.g. the universal product code (UPC)) can be used to retrieve nutritional data relating to the item from a database. The database may reside on a remote computer system (remote in this context meaning a computer system not carried by the person, for example a commercial server system, home computer, etc.). For example, the person may scan the barcode of a box of cereal and the UPC code used to retrieve nutrition information specific to that brand of cereal from the database. Barcodes on sales receipts, menus, prepackaged foods, coupons, etc., may be scanned in a weight control program, etc. These barcodes may then be used to obtain nutrition information for the items consumed.

FIG. 6 shows an image 61 of a barcode recorded on a PDA 60 by an imaging device 62, and displayed on the display 63 when a pushbutton 64 is depressed. A barcode scanner can be used to read the barcode, or alternatively image analysis software may be used to analyze the image of the barcode. An accessory device which can communicate information to the PDA may also be used as a barcode scanner.

As indicated earlier, food item identities and nutritional information can also be received from food vendors, e.g. grocery stores, on-line retailers, restaurants, vending machines, diet food retailers, etc. The PDA may prompt the person to identify the source of the food being imaged, and this information can be used to help in identification.

Images may be recorded on a nonvolatile memory medium, e.g. a flash card, and transferred to another electronic device for analysis, or to a dietician, physician, fitness trainer, etc. The person may carry a separate digital camera to record images. These may be transferred to the PDA or to another computer system for analysis. The portable electronic device referred to as a PDA in this specification may also be a digital camera. Images may also be transferred over a communications network to allow analysis elsewhere.

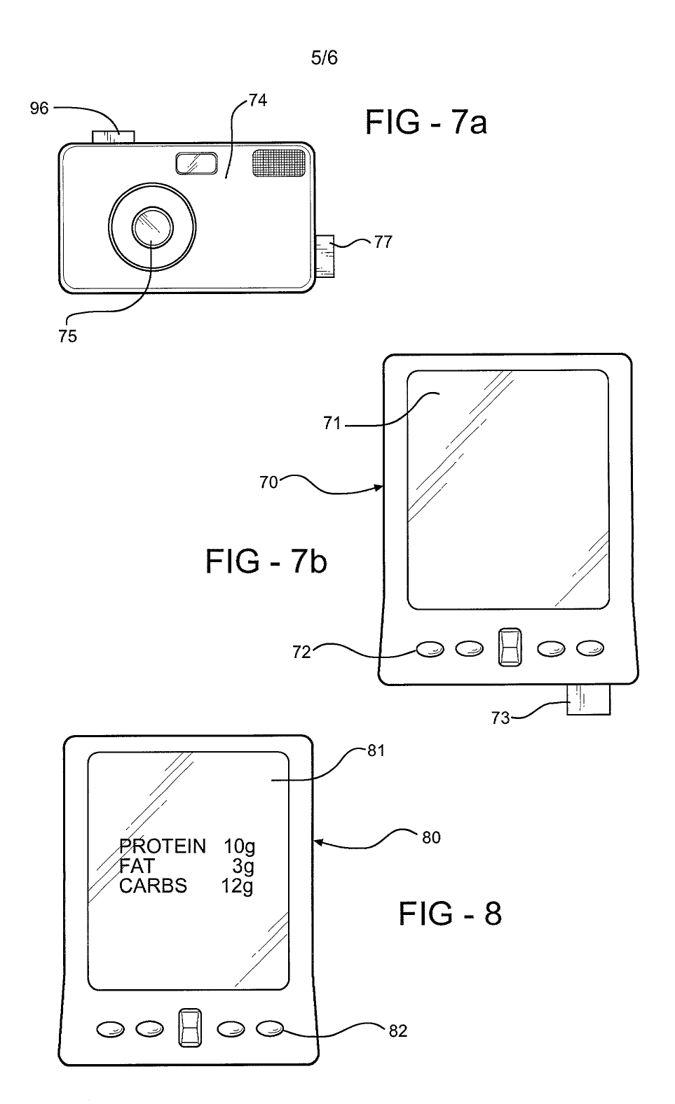

Such an arrangement is shown in FIGS. 7A and 7B. FIG. 7B illustrates a handheld PDA 70 including a display 71 and a plurality of input/control pushbuttons 72. PDA 70 further includes a memory card holder 73 for holding a memory card containing information to be inputted into the PDA. This inputted information is produced by a digital camera 74 (FIG. 7A) which includes a camera lens 75 and a pushbutton 76 for recording an image. Digital camera 74 further includes a memory card holder 77 for holding a memory card to receive the electrical output of the digital camera 74, to be removed from the digital camera, and to be transferred to the memory card holder 73 of the PDA 70. The memory card can also be used to transfer this data to another personal computer. The digital camera may be in the form of a pen, watch, personal ornamentation, etc.

FIG. 8 shows an image of nutritional information on the display 81 of a PDA 80 having input/control buttons 82. Optical character recognition can be used to extract information from this image and place it into memory for possible later transfer to a database.

A voice recording can also be produced via microphone 42 and stored on the PDA, to supplement image data or to substitute for the image data. Audio files can be transmitted over the communications network to assist generation of a diet log. Audio files can be linked to corresponding image files, or used to add information not captured by image files.

Signals from the activity sensor 45 may also be transmitted over the communications network 48. A physician, health worker, fitness trainer, diet business employee, or other person with a professional interest in the person's lifestyle may access the image data and any supplemental data to review the person's lifestyle with reference to diet goals, health goals, etc.

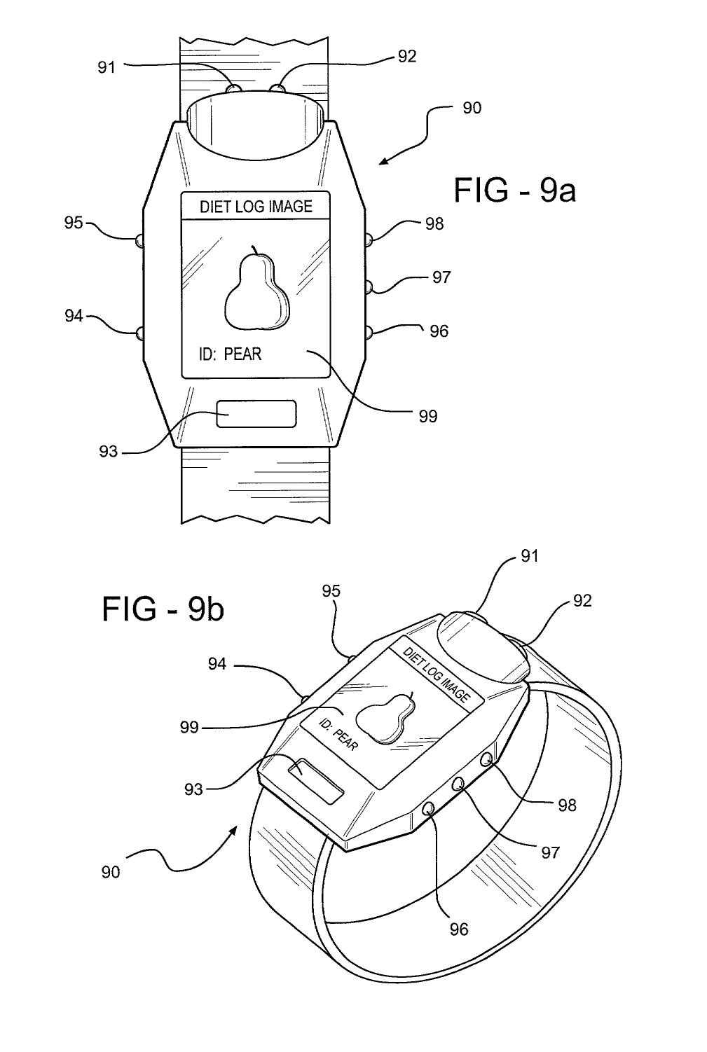

FIG. 9A diagrammatically illustrates, and FIG. 9B pictorially illustrates the present invention embodied in a wristwatch shown generally at 90 adapted to image food items for diet logging purposes. Such a device includes an IR lens 91 used as part of an IR data communications system enabling watch 90 to communicate with other devices; a camera lens 92 forming part of an image sensor; and a shutter button 93 to be pressed to capture an image or video using the image sensor.

The illustrated device further includes a mode button 94 to change the operating mode of the device. The modes may select one or more of the following functions: image recording, image display, video recording, video display, television, wireless, timepiece, calculator, personal organizer, wireless phone, video phone, Internet access device, diet log, activity sensor, physiological sensor (e.g., blood glucose), and/or any other useful function. A set button 95, a reverse button 96, a change button 97, a forward button 98, and a screen 94, are also provided, e.g. for data entry and image review processes.

The PDA devices described above with respect to FIGS. 4-9B may also be used to prepare shopping lists, or to order goods and services over a communications network as described above with respect to FIGS. 1-3. For example, if a cereal box is empty, the barcode or image of the box may be recorded so as to add the item to an order list. Images of pills consumed may be recorded, and the prescription refilled at an appropriate time based on usage. Failure to image a prescribed pill may result in an automatic reminder. Portion sizes of e.g. cereal may be more accurately obtained by combining the known number of portions consumed from the diet log and purchase frequency information e.g. obtained from a food retailer. Failure to reach activity goals may result in an exercise session being scheduled by the PDA. Failure to reach weight goals may be used to modify food orders placed by the PDA, e.g. with a store, on-line business, diet plan food retailer, etc.

While the invention has been described with respect to several preferred embodiments, it will be appreciated that these are set forth merely for purposes of example, and that many other variations, modifications and applications of the invention may be made.

What is claimed is:

1. Portable computing apparatus for aiding a user in monitoring the consumption of consumable items and in reordering said items, comprising:
a housing constructed and dimensioned to be handheld by the user;
a storage device carried by said housing for storing data concerning said items;
item-identification input means carried by said housing for inputting item-identification information identifying said items as and when to be consumed by the user;
a display carried by said housing; and
a processor within said housing programmed to process said inputted item-identification information with respect to the data stored in said storage device:
(a) to maintain a log of the items as they are consumed;
(b) to prepare a list of items to be reordered; and
(c) to selectively display said log of consumed items and said list of items to be reordered.

2. The apparatus according to claim 1, wherein said items to be consumed are food items, and said storage device includes a first database for pre-storing identification data to identify the food items as they are consumed and/or as they are to be included in the reorder list, and a second database for pre-storing nutritional information of the food items as they are consumed and/or included in the reorder list.

3. The apparatus according to claim 2, wherein said storage device further includes a third database for pre-storing personal health information relating to the personal health of the user in order to guide the user in consuming food items and/or in preparing said reorder list.

4. The apparatus according to claim 1, wherein said items to be consumed are prescribed medicaments to be taken by the user at prescribed times, said processor controlling said display to advise the user of the prescribed times, and to aid the user in timely reordering the prescribed medicaments.

5. The apparatus according to claim 1, wherein said item-identification input means includes a barcode reader for reading a barcode on a package of an item to be consumed.

6. The apparatus according to claim 1, wherein said item-identification input means includes an image sensing device for sensing the image of an item to be consumed.

7. The apparatus according to claim 1, wherein said item-identification input means includes a voice sensing device for sensing the voice of the user identifying the item, and the quantity thereof to be consumed.

8. The apparatus according to claim 1, wherein said processor further includes a recognition circuit for identifying said items to be consumed from said inputted information.

9. The apparatus according to claim 1, wherein said apparatus further includes a removable storage device for storing the information inputted in a manner which permits said storage device to be removed from said housing and to be transferred to a separate processor for processing said information.

10. The apparatus according to claim 1, wherein said housing further includes an output port to be connected via a communication channel to a remotely-located processor to enable said information inputted via said input means to be communicated to said remotely-located processor for processing therein.

11. The apparatus according to claim 1, wherein:
said items to be consumed are food items;
said housing further includes energy expenditure input means for inputting the energy expenditure of the user; and
said processor is programmed also to compute a calorie balance of the calories in the food items consumed as inputted by said item-identification input means less the calories expended as inputted by said energy-expenditure input means.

12. The apparatus according to claim 11, wherein said energy expended input means includes an indirect calorimeter for measuring and inputting the resting energy expenditure of the user, and an activity sensor for measuring and inputting the activity energy expenditure of the user.

13. The apparatus according to claim 11, wherein said item-identification input means includes a barcode reader for reading a barcode on a package of an item to be consumed.

14. The apparatus according to claim 11, wherein said item-identification input means includes an image sensing device for sensing the image of an item to be consumed.

15. The apparatus according to claim 11, wherein said item-identification input means includes a voice sensing device for sensing the voice of the user identifying the item, and the quantity thereof to be consumed.

16. The apparatus according to claim 11, wherein said processor further includes a recognition circuit for identifying said items to be consumed from said inputted information.

17. The apparatus according to claim 11, wherein said apparatus further includes a removable storage device for storing the information inputted in a manner which permits said storage device to be removed from said housing and to be transferred to a separate processor for processing said information.

18. The apparatus according to claim 11, wherein said housing further includes an output port to be connected via a communication channel to a remotely-located processor to enable said information inputted via said input means to be communicated to said remotely-located processor for processing therein.

19. The apparatus according to claim 11, wherein said storage device includes a first database for pre-storing identification data to identify the food items as they are consumed and/or as they are to be included in the reorder list, and a second database for pre-storing nutritional information of the food items as they are consumed and/or included in the reorder list.

20. The apparatus according to claim 19, wherein said storage device further includes a third database for pre-storing personal health information relating to the personal health of the user in order to guide the user in consuming food items and/or in preparing said reorder list.

21. Portable computing apparatus for aiding a user in monitoring the consumption of food items, comprising:
a housing constructed and dimensioned to be handheld;
a storage device carried by said housing for storing data concerning said food items;
an image sensing device for sensing the image of an item to be consumed or the food package thereof;
a display carried by said housing; and
a processor within said housing programmed to process said sensed image to identify the food item thereof to maintain a log of the items as they are consumed.

22. The apparatus according to claim 21, wherein said processor further includes a recognition circuit for identifying said items to be consumed from said inputted information.

23. The apparatus according to claim 21, wherein said apparatus further includes a removable storage device for storing the information inputted in a manner which permits said storage device to be removed from said housing and to be transferred to a separate processor for processing said information.

24. The apparatus according to claim 21, wherein said housing further includes an output port to be connected via a communication channel to a remotely-located processor to enable said information inputted via said input means to be communicated to said remotely-located processor for processing therein.

25. The apparatus according to claim 21, wherein said storage device includes a first database for pre-storing identification data to identify the food items as they are consumed and/or as they are to be included in the reorder list, and a second database for pre-storing nutritional information of the food items as they are consumed and/or included in the reorder list.

26. The apparatus according to claim 25, wherein said storage device further includes a third database for pre-storing personal health information relating to the personal health of the user in order to guide the user in consuming food items and/or in preparing said reorder list.

27. The apparatus according to claim 21, wherein said housing further includes energy expenditure input means for inputting the energy expenditure of the user.

28. The apparatus according to claim 21, wherein said energy expended input means includes an indirect calorimeter for measuring and inputting the resting energy expenditure of the user, and an activity sensor for measuring and inputting the activity energy expenditure of the user.

29. The apparatus according to claim 21, wherein said item-identification input means includes a barcode reader for reading a barcode on a package of an item to be consumed.

30. The apparatus according to claim 21, wherein said item-identification input means includes a voice sensing device for sensing the voice of the user identifying the item, and the quantity thereof to be consumed.

31. A method of diet management by a user comprising the steps:
recording optical images of food to be consumed by the user;
analyzing said optical images to identify the constituents of said food and the quantity of each constituent; and
computing the nutritional content of each of said constituents in said food.

32. The method according to claim 31, wherein said analyzing step is performed at the same site as said recording step.

33. The method according to claim 31, wherein said recording step is performed at a first site, and said analyzing step is performed at a second site different from said first site.

34. The method according to claim 33, wherein said optical image is recorded on a removable storage device at said first site, and said storage device is removed and transferred to a computer apparatus at said second site for analysis.

35. The method according to claim 33, wherein said optical image is recorded on a portable, handheld device at said first site, and is transmitted via a communications channel to said computer apparatus at said second site.

36. The method according to claim 35, wherein said computer apparatus also performs said analysis at said second site, and transmits the results of said analysis via said communication channel to said portable, handheld device at said first site.

37. The method according to claim 31, wherein said diet management is a part of a weight control program in which the total energy expenditure by the user is measured, and the computed nutritional content of the food consumed by the user is determined and subtracted from the measured total energy expenditure to produce a calorie balance useful for weight control.

38. The method according to claim 37, wherein the total energy expenditure measured includes a measurement of the resting energy expenditure by the user, and a measurement of the activity-related energy expenditure by the user.

39. The method according to claim 38, wherein said resting energy expenditure is measured by an indirect calorimeter carried by the user.

40. The method according to claim 38, wherein said activity-related energy expenditure is measured by an activity sensor carried by the user.
